(19) United States
(12) Patent Application Publication
(10) Pub. No.: US 2007/0222150 A1
(43) Pub. Date: Sep. 27, 2007

(54) Method and Apparatus for Awarding a Prize

(75) Inventors: Dean Wright, New South Wales (AU); Stephen Cowan, New South Wales (AU); Alan Minski, New South Wales (AU)

Correspondence Address: STERNE, KESSLER, GOLDSTEIN & FOX P.L.L.C., 1100 NEW YORK AVENUE, N.W., WASHINGTON, DC, 20005, US

(73) Assignee: PALTRONICS AUSTRALASIA PTY LIMITED, TAREN POINT, NEW SOUTH WALES, 2229 (AU)

(21) Appl. No.: 11/579,664

(22) PCT Filed: May 10, 2005
(86) PCT No.: PCT/AU05/00669

§ 371 Date: Nov. 7, 2006

(30) Foreign Application Priority Data
May 10, 2004 (AU) 2004902459

(51) Int. Cl. A63F 3/06; A63F 13/00; A63F 9/24; G06F 17/00; G06F 19/00

(52) U.S. Cl. 273/269; 463/19

(57) ABSTRACT

A method for awarding a prize is disclosed. The method includes the steps of determining (5) a trigger value T (preferably related to an operating parameter such as a turnover meter or the number of games played) from within a predetermined range of values (Lₘᵢₙ . . . Lₘₐₓ); generating (6) a number n of random values Rₐ, each within the predetermined range of values; comparing (7) each of the random values with the trigger value; and awarding the prize if a predetermined relationship exists between at least one of the random values and the trigger value. In the preferred embodiment, the method is performed at the gaming machine level in a network of linked gaming machines, and the prize is awarded in the event of one of the random values being equal to the trigger value.

### FIELD OF THE INVENTION

The preferred embodiment of the present invention relates to a method and apparatus for awarding a prize. In particular the invention relates to a method and apparatus for awarding a prize in a non-deterministic fashion.

The invention has been developed primarily for use with a plurality of interlinked gaming terminals in one or more gaming establishments and will be described hereinafter predominantly with reference to this application. However, the invention is not limited to that particular field of use and is also suitable for use with a stand-alone gaming terminal, online gaming, lotto, pools, lotteries, art unions, bingo, raffles and other games involving one or more wagers being placed upon an outcome having a finite probability of occurring.

### BACKGROUND

It is known to link gaming terminals to provide a number of additional functionalities. This includes the ability to control the awarding of a prize, as the pool of available funds is greater and the amount of funds available is known rather than having to be estimated.

Another functionality of interlinked gaming terminals is that secondary gaming is possible. The use of such functionality is intended to provide additional impetus to the gamers to play the primary games offered by the terminals and thereby win the secondary game jackpot prize in addition to any prize available to be awarded in relation to the primary game on the respective terminal. For example, for a given group of interlinked gaming terminals, a central display provides the gamers with a visual indication of a presently available jackpot prize that is being incrementally increased as the gamers operate the interlinked gaming terminals by playing the primary game. It is known by the gamers that the secondary jackpot prize will be awarded when it is incremented to a randomly selected value that is less than a predefined value. Typically, the predefined value will also be visually indicated to the gamers by the display. Hence, the probability of a jackpot being awarded generally increases over time, as the prize is progressively incremented toward the randomly selected value. The term “deterministic” is used to describe such jackpot systems wherein the probability of winning the jackpot does not remain constant over time when all other variables, for example the amount wagered, are held constant. In contrast, the term “non-deterministic” is applicable to those jackpot systems wherein the probability of winning the jackpot remains-constant over time when all other variables are held constant. The treatment of jackpot systems varies in some jurisdictions depending upon whether the system is deterministic or non-deterministic.

The discussion of the prior art within this specification is to assist the addressee understand the invention and is not an admission of the extent of the common general knowledge in the field of the invention.

### SUMMARY OF THE INVENTION

It is an object of the present invention to overcome or ameliorate at least one of the disadvantages of the prior art, or to provide a useful alternative.

According to a first aspect of the present invention there is provided a method for awarding a prize, said method including the steps of:

a) determining a trigger value from within a predetermined range of values;

b) generating a number of random values, each of said random values being within said predetermined range of values;

c) comparing each of said random values to said trigger value; and

d) awarding said prize if a predetermined relationship exists between at least one of said random values and said trigger value.

Preferably the number of random values generated in step b) is dependent upon an amount wagered. More preferably, the number of random values generated in step b) is a multiple of the amount wagered. In some preferred embodiments the multiple is selected in accordance with a predetermined normalised probability of winning.

The trigger value and the random values are preferably integers. In some preferred embodiments, the predetermined relationship is equality between said trigger value and at least one of said random values. Also preferably, the predetermined range of values corresponds to a range of possible values associated with a meter in an electronic gaming machine. For example, in one preferred embodiment the meter is a total turnover meter and the trigger value is the total turnover value at a completion of a play of the primary game of the electronic gaming machine. In another embodiment, the meter is a turnover meter, stored by at network interface card of the gaming machine, which indicates the turnover of the machine while connected to the network. In such an embodiment, the trigger value may again be the value of the turnover meter at completion of a play of the primary game. In yet further embodiments, other meters may be used: for example, a meter indicative of the number of times the primary game has been played. In such cases, the trigger value may again conveniently be selected as the value of the meter after completion of a play of the primary game.

The method is preferably implemented upon a plurality of networked electronic gaming machines.

In such cases, the steps of the method are preferably performed at the individual machine level. For example the method may be performed by a main logic controller of each gaming machine, a processor of a network interface card within each machine, or by the two in cooperation with one another.

According to another aspect of the present invention there is provided an apparatus for awarding a prize, said apparatus including:

means for determining a trigger value from within a predetermined range of values;

a random value generator for generating a number of random values, each of said random values being within said predetermined range of values; and

a processor in communication with said means for determining a trigger value and said random value generator for comparing each of said random values to said trigger value so as to award said prize if a predetermined relationship exists between at least one of said random values and said trigger value.

Preferably the random value generator includes an input adapted to receive data indicative of an amount wagered and the number of random values generated by the random value generator is dependent upon the amount wagered.

In one preferred embodiment the predetermined range of values corresponds to a range of possible values associated with a meter in an electronic gaming machine, for example a turnover meter. In said preferred embodiment the means for determining a trigger value is in communication with the turnover meter and the trigger value is equal to a turnover value at a completion of a play of the primary game of the electronic gaming machine.

### BRIEF DESCRIPTION OF THE DRAWINGS

A preferred embodiment of the invention will now be described, by way of example only, with reference to the accompanying drawings, in which:

FIG. 1 is a schematic depiction of a preferred embodiment of the invention;

FIG. 2 is a flow chart showing steps performed in a preferred method of implementing the invention; and

FIG. 3 is a schematic depiction of components of the preferred embodiment.

### DETAILED DESCRIPTION

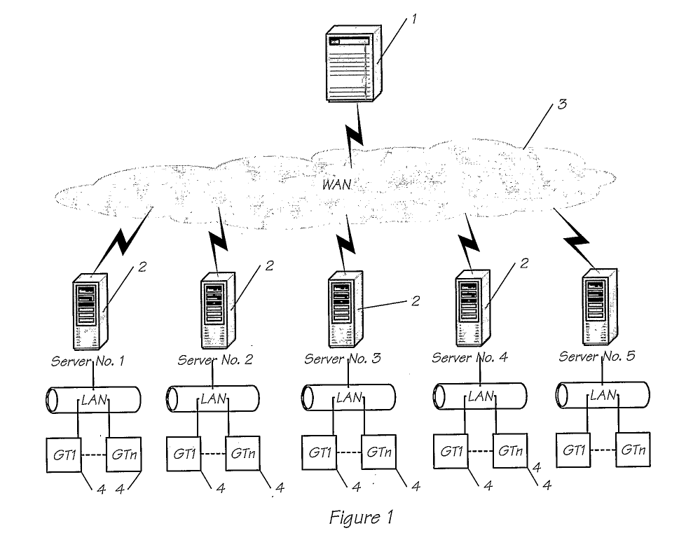

A preferred embodiment of the invention is implemented on a network of electronic gaming machines as shown in FIG. 1. Each of the electronic gaming machines 4 is connected via a local area network (LAN) to one of a plurality of auxiliary controllers 2, each of which, in turn, is connected via a wide area network (WAN) to a primary controller 1. Further details regarding another preferred embodiment of such a networked system are disclosed in the applicant's co-pending Australian Provisional Patent Application No. 2003905792, the contents of which are hereby incorporated in their entirety by way of reference. However, the rules determining the award of a prize in 2003905792 differ from those used in the preferred embodiment of the present invention. Additionally it will be appreciated by those skilled in the art that other preferred embodiments of the invention may be implemented on different hardware, for example on stand-alone gaming machines and in other contexts.

The preferred embodiment of the present invention provides for both primary gaming, which is typically, although not exclusively, of the poker machine genre, and secondary gaming, which is funded from pooled contributions drawn from each of the linked gaming machines 4. The amount of each machine's individual contribution to the pooled fund is based upon the machine's individual turnover. In a particularly preferred embodiment, the method set out below for determining whether to award a prize is carried out in relation to a prize related to this linked secondary gaming.

Focussing on the secondary gaming functionality, the primary controller 1 and the auxiliary controllers 2 are responsible for tracking the turnover and for conducting the data processing for implementation of the logic of the secondary game. However, in other embodiments, the processors in each of the individual gaming machines 4 or in network interface cards in the individual gaming machines provide the data processing for both the primary and secondary games.

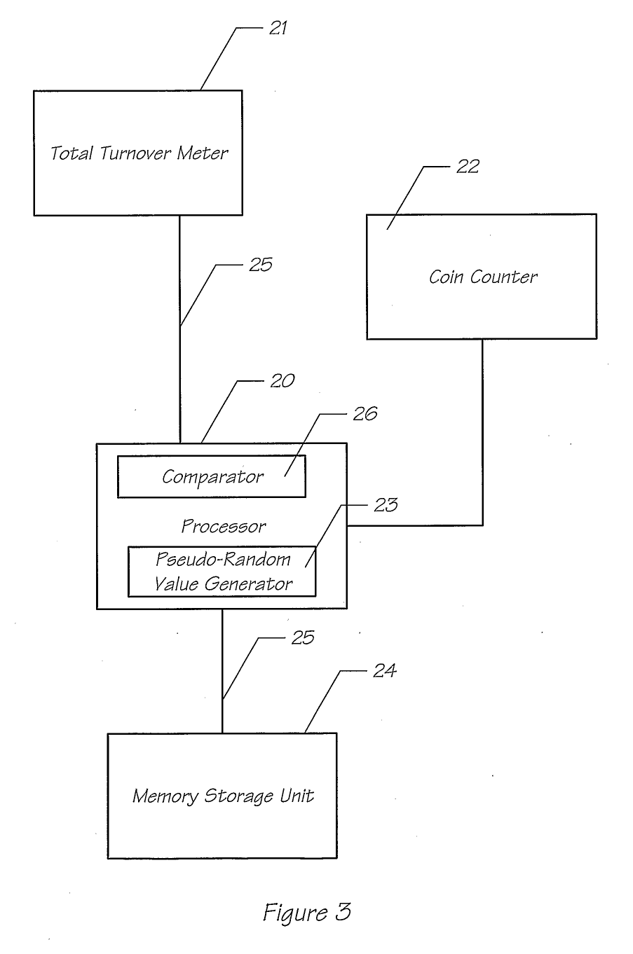

FIG. 3 is a block diagram illustrative of the components and functionality of embodiments. In the preferred embodiment, the components shown in FIG. 3 are situated in the individual gaming machines, each machine having a separate processor 20, memory 24, and so on. In some such embodiments, the functionality is carried out by the main logic controller of the gaming machine: the processor 20 is the main processor of the machine. However, in other such embodiments, the functionality is carried out by network interface cards within the gaming machines: the processor 20 is a processor on the network interface card. In other such embodiments, the functionality is carried out by the network interface card and the gaming machine itself in cooperation. For example in one embodiment, the processor 20 is on the network interface card, while the turnover meter 21 is located within the gaming machine but separate from the network interface card.

In such embodiments, each machine determines, according to the method set out below, whether a prize is payable to the player of that machine. In the event of a prize being payable on two machines simultaneously, various strategies may be used to determine how the prize should be paid. Examples include apportioning the prize with reference to the size of the most recent wager on the winning machines, splitting the prize evenly among the winning machines, paying the prize to the machine having the highest turnover in a predetermine period, and so on.

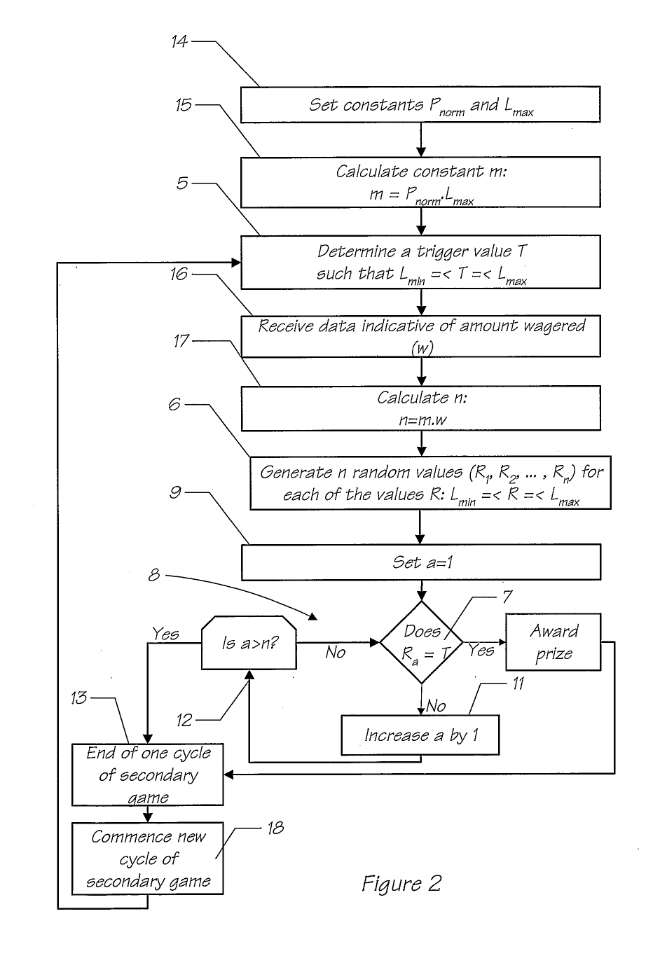

The logical steps executed by the processor 20 are shown in FIG. 2. The preferred method for awarding a prize commences at step 14 whereby a constant value is set for a desired normalised probability of winning, Pₙₒᵣₘ. This constant represents the probability of winning one game based upon a unit amount wagered. For the sake of an illustrative running example, Pₙₒᵣₘ shall be taken to be 0.01%. The processor 20 also sets a constant value for an upper limit of a range of values, Lₘₐₓ. For the sake of the illustrative running example, Lₘₐₓ shall be taken to be 99999999.

At step 15 the processor 20 calculates a multiple m, which is selected in accordance with the predetermined normalised probability of winning Pₙₒᵣₘ. More particularly, m equals Pₙₒᵣₘ multiplied by Lₘₐₓ. Multiple m is therefore 0.01% multiplied by 99999999, which rounds to 10000. Hence, m=10000 in the running illustrative example.

The processor 20 then proceeds to step 5 at which a trigger value T is determined from within a predetermined range of values. The range of values extends from a minimum Lₘᵢₙ to maximum Lₘₐₓ, which corresponds to a range of possible values associated with a meter in an electronic gaming machine. More particularly, for the purposes of a running illustrative example, we shall assume that the meter is the total turnover meter 21 of the electronic gaming machine 4, which ranges between 0 and 99999999 (as stated above, of course, a networked turnover meter maintained by the network interface card may alternatively be used). Hence, in mathematical terms, Lₘᵢₙ=0 and Lₘₐₓ=99999999 and Lₘᵢₙ≦T≦Lₘₐₓ. For embodiments in which Lₘᵢₙ is not equal to 0, some of the following formulas require amendment in a manner that is obvious to those skilled in the art. It will also be appreciated that alternative meters are used in other preferred embodiments, such as meters which track the number of games played and the monetary value of prizes awarded, etc. However, in running example, the trigger value T is set to equal the value of the total turnover meter at a completion of a play of the primary game of the electronic gaming machine 4. Hence, in the running example, if the value of the total turnover meter at the completion of a play of the primary game is $102345, then T is set equal to 102345.

In the next step 16 the processor 20 receives data indicative of an amount w wagered in that machine 4 in a particular play of the primary game. In one embodiment in which insertion of coin into the machine commits that sum irretrievably to wager on the primary game, this information is received from a coin counter 22 in the relevant electronic gaming machine 4. In other embodiments, particularly those in which a fund pool is available to a player from which he may choose a sum to wager, this data comes from the main logic controller of the gaming machine. This data is then used in step 17 to calculate a value n, which is equal to m multiplied by w. In the running example we shall assume that the amount of the wager w is $5. Hence, n is equal to 5 multiplied by 10000, that is, 50000.

The next step 6 involves the generation of a set of n random values: R₁, R₂, . . . Rₙ, each of the random values R being drawn from the predetermined range of values, Lₘᵢₙ to Lₘₐₓ. As used in this document, including the claims appended hereto, the term “random” is to be construed so as to include “pseudo-random”. Hence, a pseudo-random value generator 23, which is part of the processor 20, is used for the generation of the set of n random values. As n is equal to mw, it will be, appreciated that the number n of random values R that are generated in step 6 is dependent upon an amount w wagered by the player using one of the electronic gaming machines 4 in any one play of the primary game. Hence, in the running example the set of random values consists of 50000 randomly generated values, R₁ to R₅₀₀₀₀.

In the preferred embodiment the trigger value and each of the random values are integers, however other embodiments make use of non-integral values.

Step 7 entails a comparison of each of the random values R with the trigger value T to determine whether a predetermined relationship exists there between. This is achieved in loop 8, which commences at step 9 with an initialisation of the variable a to the value of 1. The processor then compares Rₐ (that is R₁ in the first iteration) to T to check whether a predetermined relationship exists there between. In the preferred embodiment the predetermined relationship is equality. In other words, the processor 20 uses its comparator 24 to check in comparison step 7 whether Rₐ is equal to T, however in other embodiments other relationships are used. If the predetermined relationship is present, the prize is awarded at step 10 and the process flow proceeds to step 13, which represents the end of one play of the secondary game. If not, the value of a is increased by 1 at step 11 and the loop 8 returns via the loop limiter 12 to comparison step 7 to check R₂ against T, and so on. Once a has been increased so as to exceed n, the loop limiter 12 directs the process flow to the end of the secondary game at step 13. The process flow then returns to step 5 to commence a new secondary game cycle using the same constants Pₙₒᵣₘ, Lₘₐₓ and m. In this way the normalised probability of winning Pₙₒᵣₘ can be easily held constant over subsequent cycles of the secondary game, thereby ensuring that the secondary game is non-deterministic. In each secondary game cycle, however, the actual probability of winning a game P_{act} is a function of the amount wagered w, as follows: P_{act}(w)=wPₙₒᵣₘ.

As illustrated schematically in FIG. 3, the preferred apparatus for implementing the preferred embodiment of the invention includes a processor 20 in communication via communications links 25 with the total turnover meter 21 and a memory storage unit 24 adapted to store the value of the various constants and variables, such as the value of the total turnover meter 21 at the completion of a gaming play of the primary game. This collectively forms a means for determining the trigger value T from within the predetermined range of values, Lₘᵢₙ to Lₘₐₓ. Processors suitable for this task are well known to those skilled in the art. The processor 20 includes a comparator 26 embedded within the processor 20 for comparing each of the random values R to the trigger value T in step 7.

The preferred apparatus also includes a random value generator 23, which is embedded within the processor 20 and is used for generating the set of random values R₁ to Rₙ. As noted above, this takes the form of a pseudo-random value generator, as is well known to those skilled in the fields of computing and electronics. The random value generator includes an input adapted to receive data indicative of the amount wagered w. As indicated above, in some embodiments this data is provided by a coin counter 22, which is operatively associated with a coin slot provided in each of the electronic game machines 4. The coin counter 22 is connected via communications link 25 to the processor 20. In other embodiments, this data is provided by the main logic controller of the electronic gaming machine.

The above-described preferred embodiment is a single level secondary jackpot game. However, another embodiment has multiple level secondary jackpot type games, which may run either sequentially or concurrently in each gaming cycle. The following tables set out variables and other values in connection with such a multi-level secondary game, on a network of ten inter-linked gaming machines 4 in which there is a different normalised probability Pₙₒᵣₘ of each prize being won, and in which the turnover meter is used as the predetermined range of values and the present value of the turnover meter is used as the trigger value.

Level 1 (initial jackpot value: $10,000)

| | | | | Upper limit of | | Actual |
|---|---|---|---|---|---|---|
| | Pre-game | Amount | Post-game | turnover meter | Multiple | Probability |
| EGM | Turnover | Bet (w) | Turnover (T) | (Lₘₐₓ) | (m) | (P_{act}) |
| EGM1 | $102,345.00 | $5.00 | $102,350.00 | 99999999 | 500 | 0.0005% |
| EGM2 | $12,345.00 | $1.00 | $12,346.00 | 99999999 | 100 | 0.0001% |
| EGM3 | $27,395.00 | $5.00 | $27,400.00 | 99999999 | 500 | 0.0005% |
| EGM4 | $234,897.00 | $10.00 | $234,907.00 | 99999999 | 1,000 | 0.0010% |
| EGM5 | $87,653,496.00 | $1.00 | $87,653,497.00 | 99999999 | 100 | 0.0001% |
| EGM6 | $7,645,893.00 | $2.00 | $7,645,895.00 | 99999999 | 200 | 0.0002% |
| EGM7 | $3,459,123.00 | $4.00 | $3,459,127.00 | 99999999 | 400 | 0.0004% |
| EGM8 | $37,652,934.00 | $5.00 | $37,652,939.00 | 99999999 | 500 | 0.0005% |
| EGM9 | $2,987,345.00 | $2.00 | $2,987,347.00 | 99999999 | 200 | 0.0002% |
| EGM10 | $186,395.00 | $1.00 | $186,396.00 | 99999999 | 100 | 0.0001% |
| | | $36.00 | | | | |

Level 2 (initial jackpot value: $5,000)

| | | | | Upper limit of | | Actual |
|---|---|---|---|---|---|---|
| | Pre-game | Amount | Post-game | turnover meter | Multiple | Probability |
| EGM | Turnover | Bet (w) | Turnover (T) | (Lₘₐₓ) | (m) | (P_{act}) |
| EGM1 | $102,345.00 | $5.00 | $102,350.00 | 99999999 | 5,000 | 0.0050% |
| EGM2 | $12,345.00 | $1.00 | $12,346.00 | 99999999 | 1,000 | 0.0010% |
| EGM3 | $27,395.00 | $5.00 | $27,400.00 | 99999999 | 5,000 | 0.0050% |
| EGM4 | $234,897.00 | $10.00 | $234,907.00 | 99999999 | 10,000 | 0.0100% |
| EGM5 | $87,653,496.00 | $1.00 | $87,653,497.00 | 99999999 | 1,000 | 0.0010% |
| EGM6 | $7,645,893.00 | $2.00 | $7,645,895.00 | 99999999 | 2,000 | 0.0020% |
| EGM7 | $3,459,123.00 | $4.00 | $3,459,127.00 | 99999999 | 4,000 | 0.0040% |
| EGM8 | $37,652,934.00 | $5.00 | $37,652,939.00 | 99999999 | 5,000 | 0.0050% |
| EGM9 | $2,987,345.00 | $2.00 | $2,987,347.00 | 99999999 | 2,000 | 0.0020% |
| EGM10 | $186,395.00 | $1.00 | $186,396.00 | 99999999 | 1,000 | 0.0010% |
| | | $36.00 | | | | |

Level 3 (initial jackpot value: $500)

| | | | | Upper limit of | | Actual |
|---|---|---|---|---|---|---|
| | Pre-game | Amount | Post-game | turnover meter | Multiple | Probability |
| EGM | Turnover | Bet (w) | Turnover (T) | (Lₘₐₓ) | (m) | (P_{act}) |
| EGM1 | $102,345.00 | $5.00 | $102,350.00 | 99999999 | 25,000 | 0.0250% |
| EGM2 | $12,345.00 | $1.00 | $12,346.00 | 99999999 | 5,000 | 0.0050% |
| EGM3 | $27,395.00 | $5.00 | $27,400.00 | 99999999 | 25,000 | 0.0250% |
| EGM4 | $234,897.00 | $10.00 | $234,907.00 | 99999999 | 50,000 | 0.0500% |
| EGM5 | $87,653,496.00 | $1.00 | $87,653,497.00 | 99999999 | 5,000 | 0.0050% |
| EGM6 | $7,645,893.00 | $2.00 | $7,645,895.00 | 99999999 | 10,000 | 0.0100% |
| EGM7 | $3,459,123.00 | $4.00 | $3,459,127.00 | 99999999 | 20,000 | 0.0200% |
| EGM8 | $37,652,934.00 | $5.00 | $37,652,939.00 | 99999999 | 25,000 | 0.0250% |
| EGM9 | $2,987,345.00 | $2.00 | $2,987,347.00 | 99999999 | 10,000 | 0.0100% |
| EGM10 | $186,395.00 | $1.00 | $186,396.00 | 99999999 | 5,000 | 0.0050% |
| | | $36.00 | | | | |

Level 4 (initial jackpot value: $100)

| | | | | Upper limit of | | Actual |
|---|---|---|---|---|---|---|
| | Pre-game | Amount | Post-game | turnover meter | Multiple | Probability |
| EGM | Turnover | Bet (w) | Turnover (T) | (Lₘₐₓ) | (m) | (P_{act}) |
| EGM1 | $102,345.00 | $5.00 | $102,350.00 | 99999999 | 50,000 | 0.0500% |
| EGM2 | $12,345.00 | $1.00 | $12,346.00 | 99999999 | 10,000 | 0.0100% |
| EGM3 | $27,395.00 | $5.00 | $27,400.00 | 99999999 | 50,000 | 0.0500% |
| EGM4 | $234,897.00 | $10.00 | $234,907.00 | 99999999 | 100,000 | 0.1000% |
| EGM5 | $87,653,496.00 | $1.00 | $87,653,497.00 | 99999999 | 10,000 | 0.0100% |
| EGM6 | $7,645,893.00 | $2.00 | $7,645,895.00 | 99999999 | 20,000 | 0.0200% |
| EGM7 | $3,459,123.00 | $4.00 | $3,459,127.00 | 99999999 | 40,000 | 0.0400% |
| EGM8 | $37,652,934.00 | $5.00 | $37,652,939.00 | 99999999 | 50,000 | 0.0500% |
| EGM9 | $2,987,345.00 | $2.00 | $2,987,347.00 | 99999999 | 20,000 | 0.0200% |
| EGM10 | $186,395.00 | $1.00 | $186,396.00 | 99999999 | 10,000 | 0.0100% |
| | | $36.00 | | | | |

It is apparent in this exemplary data that the actual probabilities of winning P_{act} are tailored for each of the initial jackpot values, such that higher initial jackpot values are associated with lower probabilities and vice versa.

Some multi-level preferred embodiments are adapted to selectively allow entry into the various levels dependent upon the amount wagered w in each play of the primary game. For example, in such embodiments a relatively small wager w entitles the player to participate in a solely level 1 secondary game. However, progressively larger wagers w entitle the player to participate in higher level jackpots according to predefined wager thresholds.

Although the invention has been described with reference to various preferred embodiments, it will be appreciated by those skilled in the art that the invention may be embodied in many other forms. Furthermore, while the embodiments have been described in terms of the hardware which carries out the various steps of the method, the invention may also be embodied in a computer program for causing a computer to carry out a method, and in a signal or data carrier carrying such a program.

1. A method for awarding a prize, said method including the steps of:
a) determining a trigger value from within a predetermined range of values;
b) generating a number of random values, each of said random values being within said predetermined range of values;
c) comparing each of said random values to said trigger value; and
d) awarding said prize if a predetermined relationship exists between at least one of said random values and said trigger value.

2. A method for awarding a prize according to claim 1, wherein the number of random values generated in step b) is dependent upon an amount wagered.

3. A method for awarding a prize according to claim 2, wherein the number of random values generated in step b) is a multiple of said amount wagered.

4. A method for awarding a prize according to claim 3, wherein said multiple is selected in accordance with a predetermined normalised probability of winning.

5. A method for awarding a prize according to claim 1 wherein said trigger value and said random values are integers.

6. A method for awarding a prize according to claim 1 wherein said predetermined relationship is equality between said trigger value and at least one of said random values.

7. A method for awarding a prize according to claim 1 wherein said predetermined range of values corresponds to a range of possible values associated with a meter in an electronic gaming machine.

8. A method for awarding a prize according to claim 7 wherein said meter is a turnover meter.

9. A method for awarding a prize according to claim 8 wherein said trigger value is a turnover value at a completion of a play of the primary game of said electronic gaming machine.

10. A method for awarding a prize according to claim 1 wherein said method is implemented upon a plurality of networked electronic gaming machines.

11. An apparatus for awarding a prize, said apparatus including:
means for determining a trigger value from within a predetermined range of values;
a random value generator for generating a number of random values, each of said random values being within said predetermined range of values; and
a processor in communication with said means for determining a trigger value and said random value generator for comparing each of said random values to said trigger value so as to award said prize if a predetermined relationship exists between at least one of said random values and said trigger value.

12. An apparatus for awarding a prize according to claim 11, wherein the random value generator includes an input adapted to receive data indicative of an amount wagered and whereby the number of random values generated by said random value generator is dependent upon said amount wagered.

13. An apparatus for awarding a prize according to claim 12, wherein the number of random values generated by said random value generator is a multiple of said amount wagered.

14. An apparatus for awarding a prize according to claim 13, wherein said multiple is dependent upon a predetermined normalised probability of winning.

15. An apparatus for awarding a prize according to claim 11 wherein said trigger value and said random values are integers.

16. An apparatus for awarding a prize according to claim 11 wherein said predetermined relationship is equality between said trigger value and at least one of said random values.

17. An apparatus for awarding a prize according to claim 11 wherein said predetermined range of values corresponds to a range of possible values associated with a meter in an electronic gaming machine.

18. An apparatus for awarding a prize according to claim 17 wherein said meter is a turnover meter.

19. An apparatus for awarding a prize according to claim 18 wherein said means for determining a trigger value is in communication with said turnover meter and whereby said trigger value is equal to a turnover value at a completion of a play of the primary game of said electronic gaming machine.

20. An apparatus for awarding a prize according to claim 11 wherein said apparatus includes a plurality of networked electronic gaming machines.
